(19) United States
(12) Patent Application Publication
(10) Pub. No.: US 2006/0078852 A1
(43) Pub. Date: Apr. 13, 2006

(54) Air brake training tool

(76) Inventor: Joseph Limkemann, Cedar Falls, IA (US)

Correspondence Address: ALLAN L HARMS, 2750 FIRST AVENUE NE, SUITE 420, CEDAR RAPIDS, IA, 52402, US

(21) Appl. No.: 11/170,902

(22) Filed: Jun. 29, 2005

Related U.S. Application Data
(60) Provisional application No. 60/605,050, filed on Aug. 27, 2004.

(51) Int. Cl. G09B 9/04

(52) U.S. Cl. 434/62

(57) ABSTRACT

A training tool for teaching the operation of the brake elements of a heavy duty air brake system is disclosed. Brake elements are replicated on a stand which also supports a compressed air tank and compressed air lines which couple compressed air to a brake chamber which is included in the air braking system of an air brake equipped vehicle. The brake drum of the training tool is partly cut away so that a trainee can observe the mechanical operation of the brake elements housed within the brake drum. A slack adjuster is carried on a simulated axle on which the brake drum is supported. A brake pedal is carried on the stand to activate the brakes and to facilitate a quick understanding of the interaction between the brake pedal and the brake shoes located within the brake drum. A dash valve is provided on a simulated dashboard segment so that operation of the parking brake system can be demonstrated to an observer.

### CROSS REFERENCE TO PENDING APPLICATION

This application claims priority from copending provisional patent application entitled “Air Brake Training Tool”, Ser. No. 60/605,050 filed Aug. 27, 2004. The disclosure of provisional patent application Ser. No. 60/605,050 is hereby incorporated in its entirety.

### BACKGROUND OF THE INVENTION

This invention pertains to the adjustment of air powered brakes on trucks and other large vehicles, and particularly to training of drivers and mechanics for such vehicles, in the proper adjustment of the slack adjusters used to adjust the brakes.

Large trucks and buses are typically equipped with air powered service brakes which are operated by compressed air. In addition, the parking brakes of such vehicles are engaged by complete release of compressed air from the air brake system. Due to wear, the brakes of such vehicles need adjustment of the spacing of the brake shoes from the brake drums so that application of the brake pedal of the vehicle will cause proper forcing of the brake shoes against the brake drums.

The distance of brake shoes from each brake drum when no braking is applied is controlled by a member of the braking system known as the slack adjuster which is moved by a tie rod driven by an actuating member known in the industry as the brake chamber. The slack adjuster angularly positions cam elements which apply separating force to the brake shoes of a brake drum. The slack adjuster may be adjusted so that the brake shoes are properly separated from the brake drum when no braking force is needed and properly forced against the brake drum when braking is needed.

The conventional method of adjusting the brake adjusters for each wheel is to crawl under the axles of the truck and to apply wrench force to an adjustment screw on the slack adjuster. Because proper brake adjustment is a regulatory requirement on United States highways, the brakes will be inspected by regulatory personnel at inspection opportunities. If a brake system of a wheel is found to be out of adjustment, the driver is forbidden to proceed until the brake system is brought into specification compliance. As a result it is quite useful for a driver of an air-brake equipped vehicle to know how to make the fairly straight forward adjustment of the slack adjusters.

Conventionally, drivers may be trained to make proper slack adjuster adjustments on a one-on-one basis by crawling under a truck with an instructor to lie under the truck axle at the location of the slack adjuster. There the student driver may be shown the method to adjust the slack adjuster. Because of the inconvenience of such training techniques, frequently drivers operate trucks without the training to make proper brake adjustments, in which case the driver must wait for a service technician to arrive to adjust the brakes when they are found out of adjustment. This possibility leads to excessive down time for the truck and driver.

No training tool exists to instruct a group of students at one time as to the adjustment of slack adjusters, nor to allow an instructor and one or more students to observe the operation of the brake shoes as the slack adjuster is adjusted without crawling under a truck axle.

### SUMMARY OF THE INVENTION

The present invention provides a training tool for teaching the operation of the brake elements of a heavy duty air brake system. Brake elements are replicated on a stand which also supports a compressed air tank and compressed air lines which couple compressed air to an actuator which is known in the industry as a “brake chamber”. The brake chamber is included in the air braking system of an air brake equipped vehicle.- The brake drum of the training tool is partly cut away so that a trainee can observe the mechanically operative elements of the brake equipment housed within the brake drum. A slack adjuster is carried on an axle on which the brake drum is supported. A brake pedal is also carried on the stand to provide the trainee with standard components in the truck cab and to facilitate a quick understanding of the interaction between the brake pedal and the brake shoes located within the brake drum. While standing, a trainee may practice operating the brakes and be instructed about the adjustment of the slack adjuster of the air brake system.

A pull out control knob is provided on the training tool which replicates a “dash valve” found on the dashboard of an air-brake equipped truck which is used to set the parking brakes of the truck. When the control knob is pulled out, air is exhausted from the parking brake chamber causing the brake shoes to be maximally applied against the brake drum. The operation of the parking brake system may be understood by use of the replicated dash valve.

It is a primary object of the present invention to provide a training tool to teach the operation of the brake system of a vehicle equipped with air brakes. It is also an object of the invention to provide a training tool which allows the instruction of a group of truck drivers about the adjustment of the slack adjuster components of a heavy duty air brake system. Further it is an object of the invention to facilitate the training of drivers of heavy trucks to be able to adjust the slack adjusters of the air braking system of a truck while in the field and without the assistance of a service technician. It is yet another object of the invention to provide a useful training tool for classroom teaching of student truck drivers and to train truck mechanics for proper brake adjustments.

The foregoing and other objects of the present invention will be understood from a careful examination of the detailed description which follows.

### DESCRIPTION OF THE DRAWING FIGS.

FIG. 1 is a front elevation of the preferred embodiment of the invention with the air ducts shown schematically.

FIG. 2 is an enlarged perspective of the simulated axle and brake drum assembly of the invention.

FIG. 3 is a schematic diagram of the operational parts of the invention.

### DETAILED DESCRIPTION OF THE INVENTION

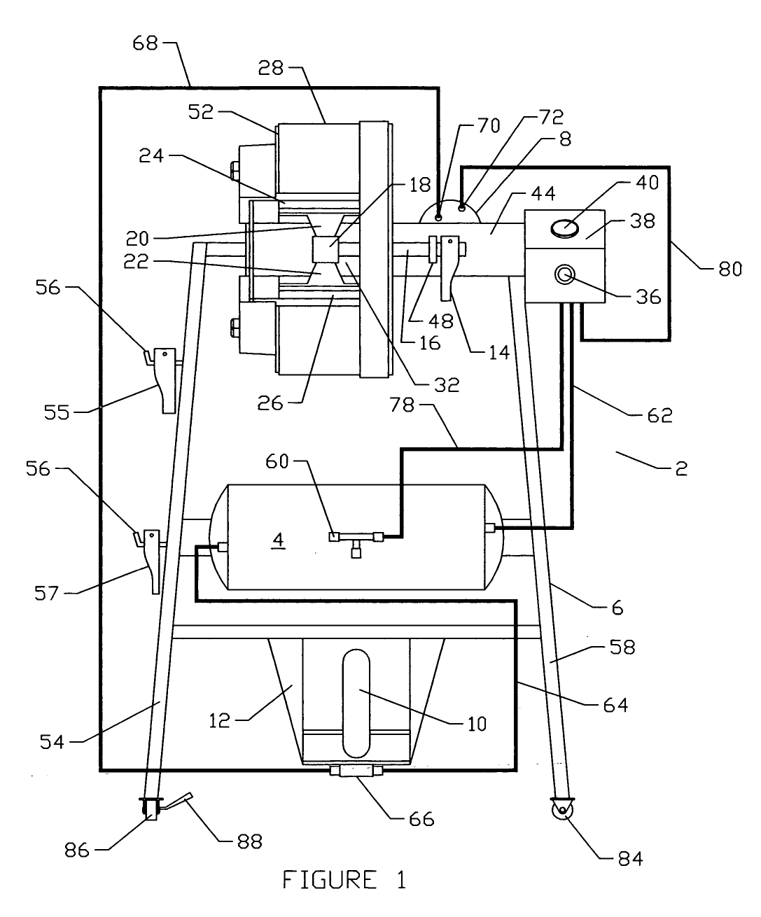

FIG. 1 discloses an air brake training tool 2 characterized by the present invention with the air lines thereof diagrammed schematically to assist in understanding of the disclosure. Training tool 2 comprises a frame 6 supporting a simulated truck axle housing provided by pipe segment 44 to which is mounted a brake drum assembly 52. Brake drum assembly 52 comprises brake drum 28, brake shoes 24, 26, and cam followers 20, 22. Frame 6 may be sized to position the brake drum assembly 52 at a height which may be comfortably viewed by a user while standing. Frame 6 supports compressed air tank 4 which may be substituted with a continuous supply of compressed air. Air tank 4 is coupled by pedal duct 64 to a pedal operated air valve 66 controlled by foot pedal 10 which is carried on pedal bracket 12. Pedal operated air valve 66 is further coupled to first air duct 68 which is joined to a brake actuator which is known in the industry and shall be referred to in this disclosure as brake chamber 8.

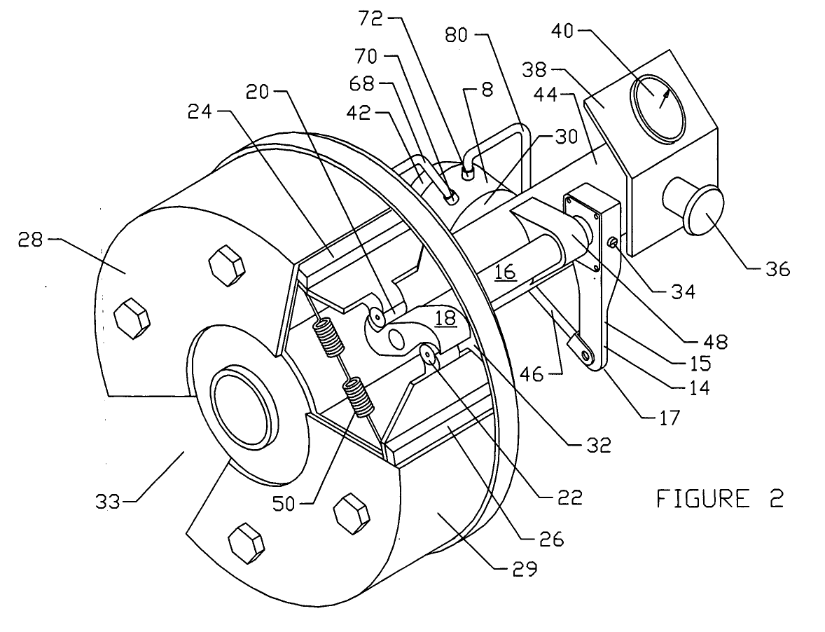

Now referring additionally to FIG. 2, in the preferred embodiment, a segment of sidewall 29 of brake drum 28 is removed creating observation opening 32 through which the action of cam 18, cam followers 20, 22, and brake shoes 24, 26 may be examined. A second observation opening 33 is disposed in the opposing side of brake drum 28 to allow observation of brake drum components from the opposite side of the brake drum 28. Brake chamber 8 comprises service brake chamber 30 and parking brake chamber 42. Pedal operated air valve 66 is selectively operated by pedal 10 such that pressurized air in tank 4 may be transferred through first air duct 68 to service brake chamber 30 of brake chamber 8 as pedal 10 is depressed, while when pedal 10 is released to return to its rest position, air pressure in service brake chamber 30 of brake chamber 8 is exhausted through pedal operated air valve 66 into the atmosphere. Pedal operated air valve 66 regulates the air pressure present within service brake chamber 30 of brake chamber 8 releasing the air pressure as the pedal 10 is allowed to come to its rest position at which it is not depressed. It is to be understood that air pressure must be elevated in parking brake chamber 42 for the service braking system is to be operated, as is true for the prototype truck.

Frame 6 is sufficiently tall to allow a user to comfortably observe the action of cam 18, cam followers 20, 22, and brake shoes 24, 26 while standing or sitting. A user may operate foot pedal 10 thereof while standing.

Frame 6 may comprise fixed alignment casters 84 supporting first legs 58 of frame 6 and swivel casters 86 which support second legs 54 thereof, such that training tool 2 may be moved easily around a training facility. Lock mechanism 88 is provided on swivel casters 86 to allow the user to selectively prevent further movement of training tool 2 when it is in position to be used for training. First legs 58 and second legs 54 may be sufficiently tall to position brake drum assembly 52 at an easily viewed height, that is, at approximately three to five feet off a floor surface, and such that a user may operate foot pedal 10 with the user's foot while still observing the brake shoes 24, 26 and the slack adjuster 14 of training tool 2.

To simulate service air brake operation of a heavy motor vehicle such as a truck, depression of the brake pedal 10 causes elevation in air pressure in the service brake chamber 30 of brake chamber 8 which causes brake chamber 8 to extend push rod 46 which is hingedly coupled to lever arm 15 of slack adjuster 14. Slack adjuster 14 is received on shaft 16 which is journaled in first bearing housing 48. First bearing housing 48 is securely mounted to pipe segment 44 and supports shaft 16 allowing it to rotate with slack adjuster 14. Shaft 16 is joined to actuator cam 18 which, when rotated forces cam followers 20, 22 to separate, thereby moving brake shoes 24, 26 outward to touch and frictionally interact with the inside surfaces of brake drum 28. As air pressure in service brake chamber 30 of brake chamber 8 decreases, push rod 46 is retracted into brake chamber 8, causing slack adjuster 14 to reversely rotate toward its rest position which in turn rotates shaft 16 resulting in brake shoes 24, 26 disengaging from their touching engagement with the interior of brake drum 28.

As brake pedal 10 is released, air pressure is bled from service brake chamber 30 into the atmosphere by pedal operated valve 66. Thus as the air in first air duct 68 decreases in pressure, brake chamber 8 is caused to retract push rod 46 which causes slack adjuster 14 to rotate in a reverse direction about the centerline of shaft 16. The reverse rotation of shaft 16 rotates cam 18 which allows cam followers 20 and 22 to approach each other, thereby reducing the outwardly directed force of brake shoes 24, 26 against brake drum 28. Spring 50 assists in urging brake shoes 24, 26 to separate from brake drum 28.

In order to train truck mechanics or drivers who may be called upon to adjust slack adjusters on a truck, training tool 2 assists to elucidate the operation of air brake shoe operation and the proper adjustment of slack adjusters. Using training tool 2, the effect of adjustment of adjustment bolt 34 of slack adjuster 14 may be demonstrated. A trainee may observe the movement of the brake shoes 24, 26 in relationship to brake drum 28 when the brake pedal 10 is depressed and released. Once this operation is understood, the trainee may be instructed on the proper separation of brake shoes 24, 26 from brake drum 28 when the brake pedal 10 is at rest, that is, not depressed. The proper gap between the shoes 24, 26 and brake drum 28 when the brake pedal is at rest is a matter of specification for a heavy duty air brake system. When the gap is excessive, an increase of air pressure in service brake chamber 30 from air tank 4 due to depression of brake pedal 10 will fail to adequately force the brake shoes 24, 26 against the brake drum 28 and insufficient braking will result.

Adjustment to achieve the proper separation of brake shoes 24, 26 from brake drum 28 is accomplished by altering the relative position of rotation of slack adjuster 14 about shaft 16. This adjustment is accomplished in the type of slack adjuster illustrated as slack adjuster 14 by manual rotation of the adjusting bolt 34. As adjusting bolt 34 is rotated, slack adjuster 14 forces shaft 16 to be incrementally rotated which results in an altered rest position of cam 18. Hence, when slack adjuster 14 is caused to rotate by extension of push rod 46 from brake chamber 8 in response to increasing air pressure within service brake chamber 30, slack adjuster 14 will rotate shaft 16 and cam 18 will move brake shoes 24, 26 toward brake drum 28 a proper distance.

The adjustment of slack adjuster 14 and the effect thereof is easily understood by use of training tool 2. Training tool 2 allows a group of trainees to be instructed at the same time because the brake training tool 2 provides easy observation of the effect of adjustment of the slack adjuster 14. Any trainee or user of training tool 2 may observe the operation of brake shoes 24, 26 relative to brake drum 28 while standing or sitting. Furthermore, a trainee or user may manually adjust adjusting bolt 34 of slack adjuster 14 while standing or even while sitting on an appropriately tall and closely located stool or chair. Training tool 2 allows an improvement in training technique over current training which necessitates both the instructor and trainee to crawl beneath a truck to view and adjust the slack adjuster in place on a truck axle.

In the case of the operation of the parking brake system of an air brake equipped vehicle, a parking brake valve known as the “dash valve” is provided on the truck dashboard which is used to fully activate the brakes of the truck when it is parked. In the training tool 2, parking brake operation is simulated by use of a dash valve knob 36 mounted upon a panel 38 which may simulate a truck dashboard. Also mounted to the panel 38 is an air pressure gauge 40 which is coupled to the air tank 4 to monitor air pressure present in the brake system. When the dash valve knob 36 is drawn out from the panel 38 to a “brake engaged” position, air pressure in the second air duct 80 is released, causing a spring (not shown) within parking brake chamber 42 of brake chamber 8 to extend push rod 46 thereby moving free end 17 of lever arm 15 of slack adjuster 14 and in response rotating shaft 16, causing cam 18 to rotate and force brake shoes 24, 26 into positive frictional contact with brake drum 28. When the parking brake is to be applied the abutment of brake shoes 24, 26 must be firm against brake drum 28 and will only be released when dash valve knob 36 is pushed in, that is, returned to “brake released” position. In that position, air pressure in air tank 4 will be coupled to parking brake chamber 42 of brake chamber 8 through parking brake supply duct 78, causing the spring within parking brake chamber 42 to compress and retract push rod 46.

From observation of FIG. 1 it can be seen that an inlet 60 including a ball valve may be included to allow addition of compressed air to air tank 4. A pop-off valve may be placed in the wall of air tank 4 such as at the coupling of pedal duct 64 to air tank 4 for a safety relief valve in case of excessive pressure in air tank 4.

Because slack adjusters vary from vehicle to vehicle, hooks 56 may be provided on leg 54 of frame 6 to facilitate storage of alternative slack adjusters 55, 57 which may be interchanged with slack adjuster 14 as desired. Because the adjustment features of alternative slack adjusters 55, 57 vary from that of adjusting bolt 34, the replacement of slack adjuster 14 with one of alternative slack adjusters 55, 57 permits the instruction of trainees as to methods to adjust more than only a first type of slack adjuster.

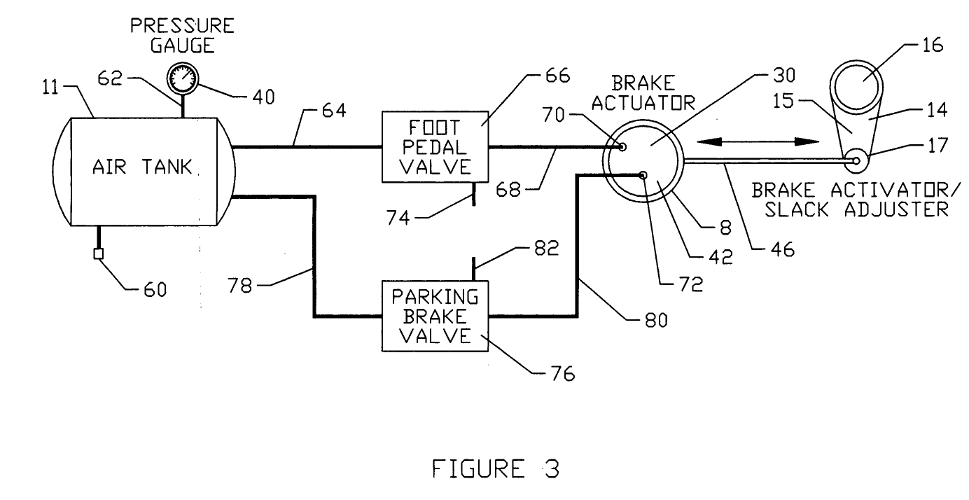

Referring to FIG. 3, the operational system of the invention is shown schematically. A supply of compressed air may be introduced to air tank 4 through inlet 60 or a constant source of compressed air may be attached to inlet 60 when repeated operation of the simulator training tool 2 will deplete the supply of compressed air in the system. Gauge line 62 communicates compressed air from air tank 4 to pressure gauge 40 so that the residual compressed air pressure may be monitored. Pedal duct 64 supplies compressed air to pedal operated air valve 66 which is controlled by foot pedal 10 (see FIG. 1). Pedal operated air valve 66 remains closed until foot pedal 10 is depressed, whereupon air under pressure in air tank 4 is permitted to pass from pedal duct 64 into first air duct 68 through first inlet port 70 and into service brake chamber 30 in which a diaphragm (not illustrated) is moved by the increasing air pressure. As foot pedal 10 is released to return to its undepressed position, compressed air in service brake chamber 30 is allowed to escape to the atmosphere via pedal exhaust port 74. As air pressure in first air duct 68 declines, the diaphragm in service brake chamber 30 of brake chamber 8 retracts push rod 46 causing slack adjuster 14 to rotate shaft 16 in a clockwise direction as diagrammed in FIG. 3. As foot pedal 10 is released, pedal operated air valve 66 gradually opens the connection between first air duct 68 and pedal exhaust port 74 causing air pressure in service brake chamber 30 to decline, which allows push rod 46 to retract in response to bias of an internal spring (not shown), thereby rotating slack adjuster 14 in a clockwise direction (as viewed in FIG. 3) and releasing the force of cam 18 against cam followers 20, 22 (see FIG. 2).

Parking brake valve 76 is controlled by dash valve knob 36 (see FIGS. 1, 2). When dash valve knob 36 is pulled out, communication between parking brake supply duct 78 is interrupted from second air duct 80 and air in second air duct 80 is exhausted to the atmosphere through second exhaust port 82. With no pressurized air in second air duct 80 which is coupled to parking brake chamber 42 of brake chamber 8 by second inlet port 72, air cylinder 8 extends push rod 46 fully, causing slack adjuster 14 to activate the brake shoes 24, 26 (see FIG. 2) fully. When parking brake dash valve knob 36 is pushed in, compressed air in parking brake supply duct 78 is once again allowed by parking brake valve 76 to pressurize spring brake chamber through second air duct 80, causing brake chamber 8 to retract push rod 46 and thereby to rotate slack adjuster 14 and shaft 16 clockwise, releasing the grip of brake shoes 24, 26 on brake drum 28.

Although the present invention has been described with reference to preferred embodiments, workers skilled in the art will recognize that changes may be made in form and detail without departing from the spirit and scope of the invention.

Having described the invention, I claim:

1. Training apparatus comprising
a frame supporting a slack adjuster and a brake drum assembly at a height easily viewed by a user,
a source of compressed air,
a selectively operated foot pedal supported on the frame and operable by the user,
the foot pedal controlling a service brake valve,
a first air duct coupling the service brake valve to the source of compressed air,
a second air duct coupling the service brake valve to a brake actuator,
the brake actuator operative to vary the position of brake shoes within the brake drum assembly,
whereby the movement of the brake shoes relative to a brake drum of the brake drum assembly may be observed as the foot pedal is depressed.

2. The training apparatus of claim 1 wherein
the frame is supported on wheels.

3. The training apparatus of claim 1 wherein
the source of compressed air is an air tank supported on the frame.

4. The training apparatus of claim 1 wherein
the brake drum assembly comprises a brake drum housing a brake actuating cam,
the brake drum having a sidewall comprising an opening therein through which movement of the brake actuating cam may be observed.

5. The training apparatus of claim 1 wherein
the slack adjuster comprises an adjustment element thereon,
the adjustment element adjustable by a user.

6. The training apparatus of claim 1 further comprising
a parking brake lever movable between a first position and second position,
the parking brake lever controlling an air valve,
the air valve coupling compressed air to a parking brake actuator when the parking brake lever is in its first position,
the air valve decompressing the parking brake actuator when the parking brake lever is in its second position,
the parking brake actuator operative to urge the brake shoes into compressing engagement with the brake drum when the parking brake lever is in its second position.

7. The training apparatus of claim 1 further comprising
an air tank containing compressed air supported on the frame,
the air tank having an input port for coupling to a source of compressed air.

8. The training apparatus of claim 1 wherein
the frame comprises a pair of fixed casters,
the frame further comprising a pair of swivel casters,
each swivel caster having a locking mechanism operative therewith.

9. The training apparatus of claim 6 wherein
the brake drum assembly comprises a brake drum housing a brake actuating cam,
the brake drum having a sidewall comprising an opening therein through which movement of the brake actuating cam may be observed,
the slack adjuster comprises an adjustment element thereon,
the adjustment element adjustable by a user while standing,
an air tank containing compressed air supported on the frame,
the frame is supported on wheels.

10. Apparatus to simulate an air brake assembly of a vehicle comprising
a brake drum assembly supported on a frame,
the brake drum assembly comprising brake shoes and a brake drum,
a slack adjuster supported on the frame and selectively operable to urge the brake shoes toward the brake drum,
a foot pedal supported on the frame and selectively operative to control coupling of compressed air to a brake actuator operative with the slack adjuster,
at least a part of the brake shoes observable by a user operating the foot pedal.

11. The apparatus of claim 10 wherein
the brake drum comprises a sidewall having at least a first opening therethrough.

12. The apparatus of claim 10 wherein
the slack adjuster may be manually adjusted by a user while the user is standing.

13. The apparatus of claim 11 wherein
an air tank is supported on the frame,
the air tank coupled to a brake service valve controlled by the foot pedal.

14. The apparatus of claim 12 wherein
the air tank has an input port to which a source of compressed air may be coupled.

15. The apparatus of claim 12 wherein
the brake service valve is coupled to a service brake actuator,
the service brake actuator operatively connected to the slack adjuster,
whereby compressed air is provided to the service brake actuator as the foot pedal is depressed.

16. The apparatus of claim 10 wherein
a parking brake valve is supported on the frame,
the parking brake valve controlled by a simulated parking brake lever,
the parking brake valve coupled to a source of compressed air,
the parking brake valve providing compressed air to a parking brake actuator when the simulated parking brake lever is in a “brake off” position,
the parking brake actuator preventing compressing engagement of the brake shoes upon the brake drum when compressed air is coupled to the parking brake actuator,
the parking brake valve operable to exhaust compressed air from the parking brake actuator when the parking brake lever is moved to a “brake engaged” position.

17. The apparatus of claim 16 wherein
the brake drum comprises a sidewall having at least a first opening therethrough.

18. The apparatus of claim 10 wherein
the frame comprises casters supporting the frame.

19. The apparatus of claim 11 wherein
a parking brake valve is supported on the frame,
the parking brake valve controlled by a simulated parking brake lever,
the parking brake valve coupled to a source of compressed air,
the parking brake valve providing compressed air to a parking brake actuator when the simulated parking brake lever is in a “brake off” position,
the parking brake actuator preventing compressing engagement of the brake shoes upon the brake drum when compressed air is coupled to the parking brake actuator,
the parking brake valve operable to exhaust compressed air from the parking brake actuator when the parking brake lever is moved to a “brake engaged” position.

20. The apparatus of claim 19 wherein
the slack adjuster may be manually adjusted by a user while the user is standing,
an air tank supported on the frame,
the air tank coupled to a brake service valve controlled by the foot pedal,
the air tank having an input port to which a source of compressed air may be coupled,
the brake service valve coupled to a service brake actuator,
the service brake actuator operatively connected to the slack adjuster,
whereby compressed air is provided to the service brake actuator as the foot pedal is depressed and compressed air is exhausted from the service brake actuator as the foot pedal is released.
